(19) United States
(12) Patent Application Publication
(10) Pub. No.: US 2024/0275776 A1
(43) Pub. Date: Aug. 15, 2024

(54) Method for the authenticated establishment of a connection between an equipment connected to at least one communication network and a server of a service provider, and corresponding devices

(71) Applicant: ORANGE, Issy-les-Moulineaux (FR)

(72) Inventors: Romuald Corbel, CHÂTILLON CEDEX (FR); Emile Stephan, CHÂTILLON CEDEX (FR); Gaël Fromentoux, CHÂTILLON CEDEX (FR); Frédéric Fieau, CHÂTILLON CEDEX (FR)

(21) Appl. No.: 18/577,490

(22) PCT Filed: Jul. 8, 2022
(86) PCT No.: PCT/FR2022/051376

§ 371 Date: Jan. 8, 2024

(30) Foreign Application Priority Data
Jul. 9, 2021 (FR) FR2107523

(51) Int. Cl. H04L 9/40

(52) U.S. Cl. CPC H04L 63/0823

(57) ABSTRACT

A method and device for providing a certificate to an item of equipment in an “edge computing” environment, which may be deployed in distributed infrastructures and in which equipment may be reconfigured, suspended, removed, reactivated or even reassigned to another master node depending on the requirements to be met. The method and device for providing a certificate make it possible, by reusing components that are already present in a communication network, to reliably authenticate such an item of equipment by providing it with a certificate the integrity of which cannot be called into question since a trusted third party that issued the certificate is an operator managing the communication network.

### FIELD OF THE INVENTION

The field of the invention is that of the certification of an item of equipment connected to a communication network. More precisely, the invention relates to a solution for providing a certificate to an item of equipment in an “edge computing” environment.

### PRIOR ART AND ITS DISADVANTAGES

A new phase in the development of “cloud computing” has emerged in the last few years. This new development is known as “edge computing” and involves processing data at the edge of the network, as close as possible to the source of the data.

“Edge computing” minimises bandwidth requirements between equipment, such as sensors, and data processing centres by undertaking the analysis as close as possible to the data sources. This approach requires the mobilisation of resources that may not be permanently connected to a network, such as laptops, smartphones, tablets or sensors. “Edge computing” also plays a key role in content ingestion and delivery solutions. In this respect, many content delivery network (CDN) architectures are based on “edge computing” architectures.

A known implementation of such an “edge computing” architecture is an architecture referred to as Kubernetes.

FIG. 1 shows in a simplified manner the architecture of a node cluster 1 compliant with the Kubernetes solution. The node cluster 1 comprises a first node 10 referred to as the management node, or “Kubernetes master”, and N compute nodes, or “workers nodes”, 11i, i∈{1, . . . ,N}, N being a natural integer.

The management node 10 comprises a controller 101, an API (Application Programming Interface) module 102 and an ETCD database 103 that consists of a dynamic configuration register for the compute nodes 11i.

A compute node 11i comprises M containers or “pods” 110j, j∈{1, . . . ,M}, M being a natural integer. Each container 110j is equipped with resources for executing one or more tasks. When a task is executed, it contributes to implementing a network service or a function, such as a DHCP (Dynamic Host Configuration Protocol) function, for example.

With a view to reducing costs and improving the flexibility of network infrastructures, “edge computing” architectures are most often multi-site architectures in which the nodes constituting the node clusters can be non-co-located. For example, a management node 10 and two compute nodes 111, 112 of a node cluster 1 are located at a site A, while three other compute nodes 113, 114, 115 are located at a remote site B.

Existing authentication solutions, such as the https (HyperText Transfer Protocol Secure) protocol, that is based on the introduction of an encryption layer compliant with the SSL (Secure Socket Layer) or TLS (Transport Layer Security) protocol into the http (HyperText Transfer Protocol) protocol, are not well suited to the context of “edge computing”.

The https protocol allows a visitor's item of equipment, such as a personal computer, to verify the identity of a website that the visitor wants to access from their item of equipment.

Thus, the item of equipment uses an X509 public authentication certificate issued by a third-party authority, that is deemed to be reliable, to access a server providing a service. Such a certificate guarantees the confidentiality and integrity of the data transmitted by the visitor via their item of equipment to the server providing a service.

Such an operating mode cannot meet the demands required to manage compute nodes. Indeed, such a management is complex because the compute nodes may be deployed in distributed, private or even mobile infrastructures, but above all, they may be reconfigured, suspended, removed, reactivated or even reassigned to another master node depending on the requirements to be met.

In addition, the compute nodes correspond, from a protocol point of view, to the visitor's item of equipment described in the example above. It can therefore be seen that applying the https solution to an “edge computing” architecture is not appropriate.

There is therefore a need to propose a solution for managing equipment belonging to an “edge computing” architecture that do not have some or all of the above-mentioned disadvantages.

### SUMMARY OF THE INVENTION

The invention addresses this need by proposing a system comprising at least one item of equipment connected to at least one communication network, at least one network address configuration server, at least one certificate creation module, at least one domain name server and at least one server of a service provider.

Such a system is particular in that:
the item of equipment transmits to the configuration server a request for allocating at least one network address comprising at least one hash of a physical address of said item of equipment,
the configuration server generates a request for creating a certificate associated with said item of equipment comprising the hash of a physical address of said item of equipment, a certificate associated with said configuration server and at least one network address allocated to said item of equipment by said configuration server,
the configuration server transmits said creation request to the certificate creation module,
the certificate creation module generates, from the information comprised in the creation request, a certificate associated with said item of equipment and a certification token corresponding to said certificate,
the certificate creation module transmits, to the domain name server, a request for associating said certificate, said certification token and said hash of said certification token with at least one domain name,
the domain name server associates, with at least one domain name, the certificate associated with said item of equipment, the corresponding certification token and the hash of said certification token,
following the acknowledgement of the association with a domain name, the item of equipment receives the certification token and the hash of said certification token from the configuration server.

The solution covered by the present invention makes it possible, by reusing components that are already present in a communication network, to authenticate an item of equipment reliably that is connected to a communication network but not managed by the operator managing the communication network in question by providing it with a certificate the integrity of which cannot be called into question since the trusted third party who issued the certificate is the operator managing the communication network.

Such a solution also reduces the number of exchanges required to obtain a certificate for such an item of equipment, which is particularly interesting in a context of “edge computing” where agility is essential, since the first message transmitted by the item of equipment already triggers the operations leading to the creation of a certificate. Similarly, using existing messages limits the load on the network.

To make all this possible, the solution consists in taking advantage of the transmission of a network address allocation request by an item of equipment seeking to connect to a communication network to introduce into this request a query to obtain a certificate. Such a query results in the introduction of a hash of a physical address of the item of equipment into the allocation request.

A configuration server detecting the presence of this hash of a physical address of the item of equipment in a network address allocation request understands that the item of equipment wants to obtain a certificate and then triggers a certificate creation procedure with a certificate creation module. Such a module can be co-located with the configuration server or with the domain name server, in which an association of said certificate with at least one domain name provided by the configuration server is stored.

Finally, knowing that the configuration server can allocate a plurality of network addresses, or “address pool”, to the same item of equipment, the certificate created is associated with this address pool.

Finally, the server of the service provider can simply use the configuration token to verify the authenticity and integrity of the certificate associated with the item of equipment and thus authorise the establishment of a connection with the item of equipment. The establishment of such a connection corresponds, for example, to the integration of the item of equipment into a Kubernetes architecture as a compute node.

Thus, the server of a service provider can perform a double certification of the item of equipment, as is the case for https connections.

An object of the present invention relates more particularly to a method for the authenticated establishment of a connection between an item of equipment connected to at least one communication network and a server of a service provider, said method comprising the following steps implemented by said item of equipment:
transmitting to a network address configuration server a request for allocating at least one network address comprising at least one hash of a physical address of said item of equipment,
receiving a certification token corresponding to a certificate created by a certificate creation module from at least said hash of a physical address of said item of equipment, and a hash of said certification token
transmitting a request for establishing a connection with said server of a service provider comprising at least said corresponding certification token and said hash of said certification token.

As the configuration server is involved in the providing process, it is possible to use the messages exchanged with the item of equipment during the renewal of the network address allocation to transmit, to the certificate creation module, a request for maintaining in force the certificate associated with said item of equipment, said maintenance in force request comprising said certificate token and said certificate associated with said configuration server.

Thus, there is no need to exchange additional messages, which contributes to the responsiveness of the exchanges and limits the load on the network.

Such a method for the authenticated establishment of a connection further comprises the following steps:
in response to the authentication of said item of equipment by said server of a service provider from said certification token and said hash of said certification token, receiving a message acknowledging the establishment of said connection with said server of a service provider.

The invention further relates to a method for providing a certification token associated with an item of equipment connected to at least one communication network for the authenticated establishment of a connection between said item of equipment and a server of a service provider, said method comprising the following steps implemented by a network address configuration server:
receiving a request for allocating at least one network address comprising at least one hash of a physical address of said item of equipment,
obtaining a certificate associated with said item of equipment and a certification token corresponding to said certificate from the hash of a physical address of said item of equipment, a certificate associated with said configuration server and at least one network address allocated to said item of equipment by said configuration server,
transmitting said certification token and said hash of said certification token to said item of equipment.

In a particular embodiment, this method further comprises a step of generating the certificate associated with said item of equipment and the certification token corresponding to said certificate from the hash of a physical address of said item of equipment, a certificate associated with said configuration server and at least one network address allocated to said item of equipment by said configuration server.

Such a method for providing a certification token further comprises the following steps:
transmitting, to the domain name server, a request for associating said certificate, said certification token and said hash of said certification token with at least one domain name.

As part of the renewal of the network address allocation, the configuration server notifies the certificate creation module that it must maintain in force the association of said certificate, said certification token and said hash of said certification token with said at least one domain name.

Finally, the invention relates to computer program products comprising program code instructions for implementing the methods as described previously, when they are executed by a processor.

The invention also relates to a computer-readable storage medium on which are saved computer programs comprising program code instructions for implementing the steps of the methods according to the invention as described above.

Such a storage medium can be any entity or device able to store the programs. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer programs contained therein can be executed remotely. The programs according to the invention can be downloaded in particular on a network, for example the Internet network.

Alternatively, the storage medium can be an integrated circuit in which the programs are embedded, the circuit being adapted to execute or to be used in the execution of the above-mentioned methods that are the subject of the invention.

### LIST OF FIGURES

Other purposes, features and advantages of the invention will become more apparent upon reading the following description, hereby given to serve as an illustrative and non-restrictive example, in relation to the figures, among which:

FIG. 1: this figure shows in a simplified manner the architecture of a node cluster 1 compliant with the Kubernetes solution,

FIG. 2: this figure shows a system in which the present invention can be implemented,

FIG. 3: this figure shows a first part of the execution of the methods that are the subject of the invention,

FIG. 4 this figure shows the next steps of the methods that are the subject of the present invention,

FIG. 5 this figure shows an item of equipment capable of implementing the method for the authenticated establishment of a connection between an item of equipment connected to at least one communication network and a server of a service provider that is the subject of the present invention,

FIG. 6 configuration server capable of implementing the various methods that are the subject of the present invention.

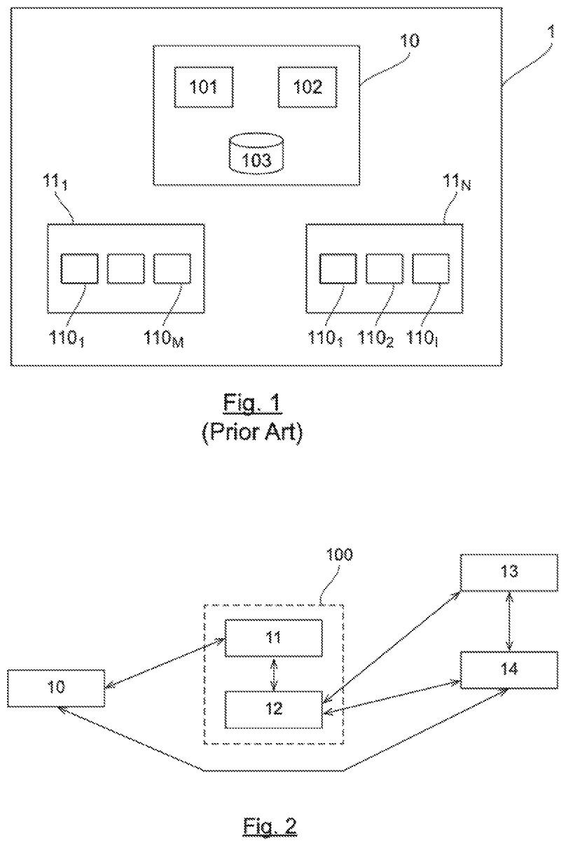

### DETAILED DESCRIPTION OF THE EMBODIMENTS OF THE INVENTION

The general principle of the invention is based on obtaining a certificate for an item of equipment located in an “edge computing” environment. The data required to obtain such a certificate is exchanged via messages normally used when an item of equipment seeks to connect to a communication network. The necessary information is entered into existing fields of these messages. Such a solution does not increase the load on the network, as it does not require additional messages to be transmitted. The data exchanged being entered into existing fields of messages, it is not too large either, which further helps not to increase the load of the network.

Such a solution also has the advantage of being fast, which makes it particularly interesting for architectures requiring frequent dynamic configurations. Indeed, the present solution transmits the data needed to create a certificate from the very first message.

In relation to [FIG. 2], a system in which the present solution may be implemented is now presented.

Such a system comprises at least one item of equipment 10 connected to at least one communication network (not shown in the figures), at least one network address configuration server 11, such as a DHCP (Dynamic Hosts Configuration Protocol) server, at least one certificate creation module 12, at least one domain name server 13, such as a DNS server, and at least one server of a service provider 14, which may or may not be independent of the communication network operator.

The item of equipment 10 may be a mobile terminal as well as a server, a node or a container according to the Kubernetes solution, or even a sensor. It may also be a virtualised item of equipment.

In one embodiment, the configuration server 11 and the certificate creation module 12 can be co-located in the same item of equipment 100 as shown in FIG. 2. In another embodiment, the certificate creation module 12 may be co-located with the domain name server 13 or integrated into it. In yet another embodiment, the certificate creation module 12 may be physically distinct from the configuration server 11 and the domain name server 13.

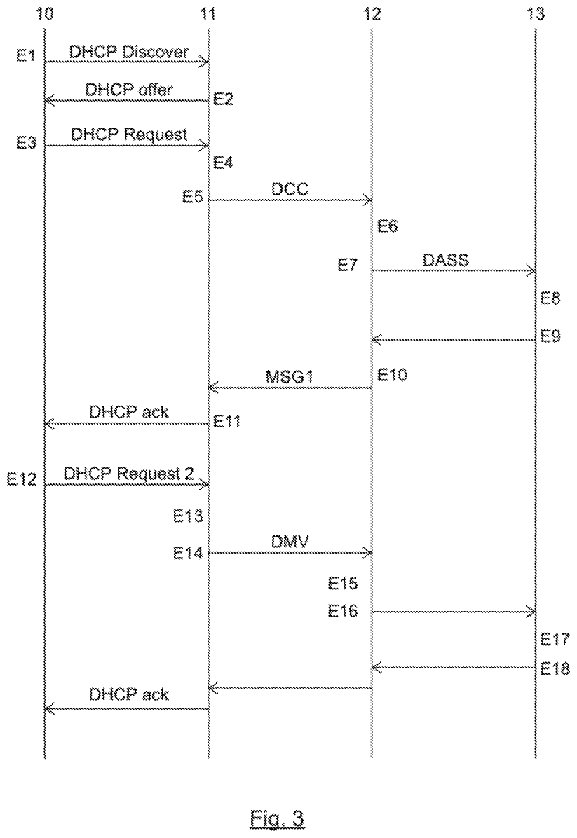

With reference to the system described in FIG. 2, a first part of the execution of the methods that are the subject of the invention is now described. The various steps implemented when executing these methods within the system previously described are shown in the form of a diagram in [FIG. 3].

In a step E1, the item of equipment 10 seeks to connect to a communication network. To this end, the item of equipment 10 sends a DHCP Discover query to the configuration server 11 so that the latter allocates to it one or more network addresses, such as IPv4 or IPv6 addresses.

In a step E2, upon receipt of the Discover DHCP request transmitted by the item of equipment 10, the configuration server 11 proposes, in a standard manner, one or more network addresses to the item of equipment 10 by transmitting a DHCP Offer message.

In another example, the configuration server 11 can implement an ACME-STAR delegation method or a “Delegated Credentials” method upon receipt of the Discover DHCP query transmitted by the item of equipment 10. These methods are described in the document referenced Acme-Star RFC 8739 published by the IETF.

The delegated item of equipment 10 can thus receive, in this case in a DHCP Offer message, a possibly hashed temporary certificate calculated based on a private key of the delegating configuration server 11.

In a step E3, the item of equipment 10 validates the network address allocation proposal received during step E2 and transmits, to the configuration server 11, a DHCP Request query validating network addresses from among those proposed and comprising parameters relating to the creation of a certificate. In an existing field of this DHCP Request query, the item of equipment 10 adds parameters intended to be used for generating a certificate associated with the item of equipment 10. Such parameters are: a public key PUB_KEY_CPE of the item of equipment 10, a hash HASH_CPE of a physical address of the item of equipment 10, such as a MAC (Medium Access Control) address, and a parameter TYP_HASH on how the hash HASH_CPE is calculated. In another example, these various parameters can be transmitted in the form of a certificate that can be hashed.

In one embodiment, the hash HASH_CPE of a physical address of the item 10 can be transmitted as early as step E1 in the DHCP Discover query.

Upon receipt of the DHCP Request query, in a step E4, the configuration server 11 processes the information relating to the allocation of network addresses comprised in this query in a standard manner. When this DHCP Request query is processed, the configuration server 11 detecting the presence of parameters relating to the creation of a certificate in a field of the DHCP Request query, that is the public key PUB_KEY_CPE, the hash HASH_CPE or the parameter TYP_HASH, extracts this information and generates a request for creating a DCC certificate associated with the item of equipment 10.

The request for creating a DCC certificate comprises: the public key PUB_KEY_CPE of the item of equipment 10, the hash HASH_CPE of a physical address of the item of equipment 10, a certificate CertDHCP associated with the configuration server 11, at least one network address IP_CPE allocated to said item of equipment 10 by the configuration server 11 during step E4 (or a pool of network addresses POOL_IP_CPE allocated to the item of equipment 10), and finally the parameter TYP_HASH on how the hash HASH_CPE is calculated. The request for creating a DCC certificate may also comprise a domain name, for example “CNT.example.com”, with which the certificate is intended to be associated.

In a step E5, the configuration server transmits the request for creating a DCC certificate to the certificate creation module 12.

Upon receipt of the request for creating a certificate associated with the item of equipment 10, the certificate creation module 12 generates, during a step E6, a certificate CERT_CPE associated with the item of equipment 10 from the information comprised in the creation request DCC.

Such a certificate CERT_CPE corresponds to a network address allocated to the item of equipment 10. Thus, the certificate creation module 12 creates as many certificates CERT_CPE associated with the item of equipment 10 as it has network addresses. In another embodiment, the certificate creation module 12 creates a single certificate CERT_CPE associated with the item of equipment 10 that applies to the network address pool POOL_IP_CPE allocated to the item of equipment 10. Such a certificate CERT_CPE includes the values of the physical address of the item of equipment 10 and of one or more network addresses chosen during step E3 by the item of equipment 10, in fields of the certificate CERT_CPE such as the Common Name (CN) or SAN fields, for example.

The certificate creation module 12 also generates a certification token CNT (Certificate Network Token) corresponding to the certificate CERT_CPE associated with the connectivity of the item of equipment 10 to the network of 11. Such a certification token CNT is a compact form of the certificate CERT_CPE associated with the item of equipment 10. More particularly, this certification token CNT comprises information relating to the hash HASH_CPE of the physical address of the item of equipment 10, the hash HASH_CERT_CPE of the certificate CERT_CPE associated with the item of equipment 10, and an identifier CN_CM of the certificate creation module 12.

It is this certification token CNT that will be used by the item of equipment 10 in all cases where the latter needs to provide authentication material to access a service. This certification token CNT being is a compact form of the certificate CERT_CPE associated with the item of equipment 10, it can be introduced into many existing messages without increasing the payload of the latter in a detrimental manner. Thus, implementing the solution that is the object of the present patent application does not impose too heavy a load in a communication network.

In a step E7, the certificate creation module 12 transmits a request DAss for associating the certificate CERT_CPE associated with the item of equipment 10 thus generated with the domain name “CNT.example.com” with which the certificate CERT_CPE is intended to be associated to the domain name server 13.

Such an association request DAss comprises: the certificate CERT_CPE associated with the item of equipment 10, the corresponding certification token CNT, a hash HASH_CNT of the certification token CNT and a parameter TYP_HASH_CNT on how the hash HASH_CNT is calculated. In one embodiment, the parameter TYP_HASH_CNT on how the hash HASH_CNT is calculated may comprise a public key of the certificate creation module 12.

Upon receiving the association request DAss, the domain name server 12 can, if it wants to do so, verify the identity of the configuration server 11 by requesting a certificate corresponding to the configuration server 11 from the certificate creation module 12. Such a step is not shown in FIG. 3.

In a step E8, the domain name server 12 stores all the information comprised in the association request DAss in a table and associates it with the “CNT.example.com” domain name.

Once the association between all the information comprised in the association request DAss and the domain name has been performed, the domain name server 12 informs the certificate creation module 12 in a step E9.

In turn, the certificate creation module 12 informs the configuration server 11 of the creation of the certificate CERT_CPE associated with the item of equipment 10 in a step E10. To do this, the certificate creation module 12 transmits to the configuration server 11 a message MSG1 comprising the corresponding certification token CNT, the hash HASH_CNT of the certification token CNT and the parameter TYP_HASH_CNT on how the hash HASH_CNT is calculated.

Finally, the configuration server 11 sends, in a step E11, a message acknowledging a network address assignment DHCP ack. In an existing field of this message DHCP ack, the item of equipment 10 adds the corresponding certification token CNT, the hash HASH_CNT of the certification token CNT and the parameter TYP_HASH_CNT on how the hash HASH_CNT is calculated.

At the end of step E11, the item of equipment 10 thus has a certification token CNT that will be used by the item of equipment 10 in all cases where the latter needs to provide authentication material to access a service. It will be noted that the item of equipment 10 does not have its certificate CERT_CPE and does not know the domain name “CNT.example.com” associated with its certificate CERT_CPE. These two items of information are only stored in the domain name server 12.

In the DHCP protocol, it is intended that the network address allocations, or DHCP lease, are renewed on a regular basis. In the present solution, the messages exchanged between the various elements of the system of FIG. 2 are used to maintain in force the certificate CERT_CPE.

Thus, when in a step E12 the item of equipment 10 sends a DHCP Request message 2, requesting the extension of the allocation of its network address to the configuration server 11, it adds to an existing field of this DHCP Request message 2 the corresponding certification token CNT, the hash HASH_CNT of the certification token CNT and the parameter TYP_HASH_CNT on how the hash HASH_CNT is calculated.

Upon receipt of the DHCP Request message 2, in a step E13, the configuration server 11 processes the information relating to the renewal of the network address allocation in a standard manner. When processing this DHCP Request message 2, the configuration server 11 detecting the presence of parameters relating to maintaining in force the certificate CERT_CPE in a field of the DHCP Request message 2, that is the token CNT, the hash HASH_CPE or the parameter TYP_HASH, extracts this information and generates a request for maintaining in force the DCC certificate CERT_CPE.

The request for maintaining in force DMV the certificate CERT_CPE comprises: the certification token CNT, the hash HASH_CNT of the certification token CNT, the parameter TYP_HASH_CNT on how the hash HASH_CNT is calculated, and possibly an item of information relating to a time limit for processing the maintenance in force request DMV of the query and the certificate CERT_DHCP of the configuration server 11.

In a step E14, the configuration server transmits the request for maintaining in force DMV the certificate CERT_CPE to the certificate creation module 12.

In a step E15, the certificate creation module 12 verifies the identity of the configuration server 11 from the certificate CERT_DHCP of the configuration server 11 and verifies the authenticity of the certification token CNT from the hash HASH_CNT of the certification token CNT, and the parameter TYP_HASH_CNT on how the hash HASH_CNT is calculated.

Once these verifications have been performed, the certificate creation module 12 transmits to the domain name server 13, in a step E16, a request for extending the association of the certificate CERT_CPE corresponding to the certification token CNT, with the domain name “CNT.example.com”. Such an extension request comprises: the certificate CERT_CPE, the certification token CNT, the hash HASH_CNT of the certification token CNT and the parameter TYP_HASH_CNT on how the hash HASH_CNT is calculated.

In a step E17, the domain name server 13 extends the association of the certificate CERT_CPE corresponding to the certification token CNT, with the domain name “CNT.example.com”.

In a step E18, a message confirming the maintenance in force of the certificate CERT_CPE is cascaded from the domain name server 13 via the certificate creation module 12, then from the configuration server 11 to the item of equipment 10.

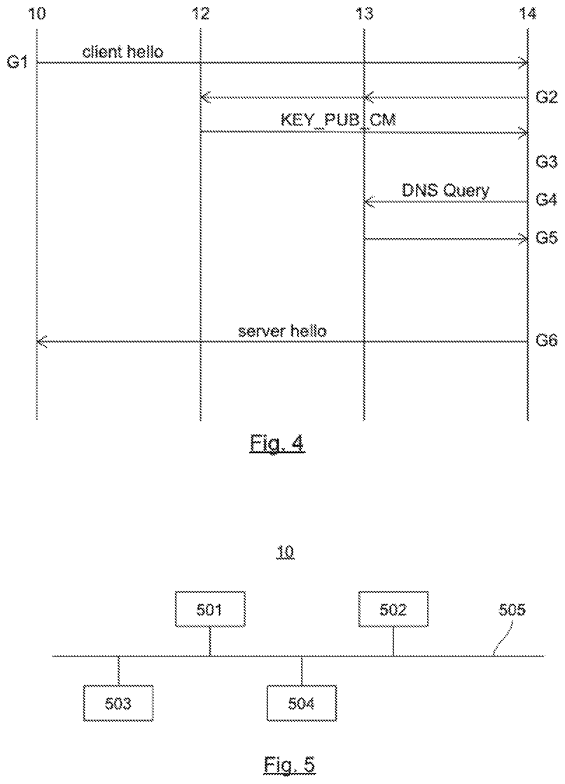

Now that the item of equipment 10 has a certificate, it can establish a connection with a server of a service provider 14. [FIG. 4] shows the next steps of the methods that are the subject of the present invention.

In a step G1, the item of equipment 10 wanting to establish a connection with the server of a service provider 14 transmits to the latter a TLS client Hello message. In an existing field of this TLS client Hello message, the item of equipment 10 adds the certification token CNT, the hash HASH_CNT of the certification token CNT and the parameter TYP_HASH_CNT on how the hash HASH_CNT is calculated. In practice, the certification token CNT can be carried by any secure exchange protocol such as the QUIC protocol, in a field of any application protocol such as HTTP carried below any combination of protocols guaranteeing the integrity of the exchange, but also in an In-situ OAM (IOAM) field described in https://datatracker.ietf.org/doc/html/draft-ietf-ippm-ioam-data-17.txt.

In a step G2, the server of a service provider 14 obtains the public key KEY_PUB_CM of the certificate creation module 12. The public key KEY_PUB_CM is, for example, a public field of the X509 certificate of the certificate creation module 12 obtained, after step G1 or beforehand, for example via a secure tunnel established between the server of a service provider 14 and the certificate creation module 12.

Using the public key KEY_PUB_CM of the certificate creation module 12, the server of a service provider 14, in a step G3, verifies the authenticity of the certification token CNT using the public key PUB_KEY_CM of the certificate creation module 12 and the hash HASH_CNT of the certification token CNT and information TYP_HASH_CNT on how the hash HASH_CNT is calculated.

Once this verification has been performed, the server of a service provider 14 asks, in a step G4, the domain name server to provide it with the certificate CERT_CPE associated with the certification token CNT that it has just verified. To do this, the server of a service provider 14 transmits a DNS Query message comprising, in an existing field, the certification token CNT.

In a step G5, the domain name server 13 extends returns the certificate CERT_CPE corresponding to the certification token CNT received.

In a step G6, the server of a service provider 14 then verifies that the certificate CERT_CPE corresponds to the network address(es) supplied in the TLS client Hello message, knowing that such a certificate CERT_CPE is delivered for one or more network addresses.

Once the item of equipment 10 has been authenticated, the server of a service provider 14 sends a Server Hello message to the item of equipment 10, thereby finalising the establishment of the connection between the latter and the server of a service provider 14 in a step G6.

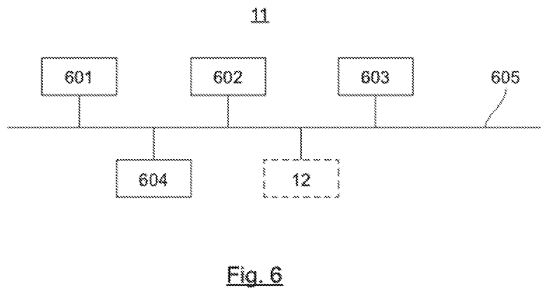

FIG. 5 shows an item of equipment 10 capable of implementing the method for the authenticated establishment of a connection between an item of equipment connected to at least one communication network and a server of a service that is the subject of the present invention.

an item of equipment 10 may comprise at least one hardware processor 501, a storage unit 502 and an interface 503, and at least one network interface 504 which are connected to each other via a bus 505. Naturally, the components of the item of equipment 10 can be connected by means of a connection other than a bus.

The processor 501 controls the operations of the item of equipment 10. The storage unit 502 stores at least one program for implementing the various methods that are the subject of the invention to be executed by the processor 501, and various data, such as parameters used for calculations performed by the processor 501, intermediate data for calculations performed by the processor 501, etc. The processor 501 may be formed by any known and appropriate hardware or software, or by a combination of hardware and software. For example, the processor 801 can be formed by a dedicated hardware such as a processing circuit, or by a programmable processing unit such as a Central Processing Unit which executes a program stored in a memory thereof.

The storage unit 502 may be formed by any appropriate means capable of storing the program or programs and data in a computer-readable manner. Examples of storage devices 502 include non-transitory computer-readable storage media such as semiconductor memory devices, and magnetic, optical or magneto-optical recording media loaded into a read/write device.

The interface 503 provides an interface between the item of equipment 10 and a network address configuration server.

As for the network interface 504, it provides a connection between the item of equipment 10 and at least one server of a service provider with which it wants to establish a connection in an authenticated manner.

FIG. 6 shows a configuration server 11 capable of implementing the various methods that are the subject of the present invention.

A configuration server 11 may comprise at least one hardware processor 601, a storage unit 602, an interface 603, and at least one network interface 604 which are connected to each other via a bus 605. In one embodiment, the configuration server further comprises a certificate creation module 12. Naturally, the components of the configuration server 11 can be connected by means of a connection other than a bus.

The processor 601 controls the operations of the configuration server 11. The storage unit 602 stores at least one program for implementing the various methods that are the subject of the invention to be executed by the processor 601, and various data, such as parameters used for calculations performed by the processor 601, intermediate data for calculations performed by the processor 601, etc. The processor 601 may be formed by any known and appropriate hardware or software, or by a combination of hardware and software. For example, the processor 601 can be formed by a dedicated hardware such as a processing circuit, or by a programmable processing unit such as a Central Processing Unit which executes a program stored in a memory thereof.

The storage unit 602 may be formed by any appropriate means capable of storing the program or programs and data in a computer-readable manner. Examples of storage devices 602 include non-transitory computer-readable storage media such as semiconductor memory devices, and magnetic, optical or magneto-optical recording media loaded into a read/write device.

The interface 603 provides an interface between the configuration server 11 and at least one item of equipment 10 wanting to connect to a communication network.

As for the network interface 604, it provides a connection between the configuration server 11 and a domain name server.

1. A method for authenticated establishment of a connection between an item of equipment connected to at least one communication network and a server of a service provider, said method being implemented by said item of equipment and comprising:
transmitting to a network address configuration server a request for allocating at least one network address comprising at least one hash of a physical address of said item of equipment,
receiving a message comprising a certification token generated from at least the at least one said hash of the physical address of said item of equipment, and a hash of said certification token, and
transmitting a request for establishing a connection with said server of the service provider comprising at least said certification token and said hash of said certification token.

2. The method according to claim 1 further comprising:
in response to authentication of said item of equipment by said server of the service provider from said certification token and said hash of said certification token, receiving a message acknowledging the establishment of said connection with said server of the service provider.

3. A method for providing a certification token associated with an item of equipment connected to at least one communication network for authenticated establishment of a connection between said item of equipment and a server of a service provider, said method being implemented by a network address configuration server and comprising:
receiving a request for allocating at least one network address comprising at least one hash of a physical address of said item of equipment,
obtaining a certificate associated with said item of equipment and a certification token corresponding to said certificate, the certificate and the token being generated from the at least one hash of the physical address of said item of equipment, a certificate associated with said configuration server and at least one network address allocated to said item of equipment by said configuration server,
transmitting said certification token and a hash of said certification token to said item of equipment.

4. The method according to claim 3 further comprising:
transmitting, to a domain name server, a request for associating said certificate, said certification token and said hash of said certification token with at least one domain name.

5. The method according to claim 4 further comprising, in response to a request for extending an allocation of said network address allocated to said item of equipment, transmitting a request for extending the association of said certificate.

6. The method according to claim 3, further comprising generating the certificate associated with said item of equipment and the certification token corresponding to said certificate from the at least one hash of the physical address of said item of equipment, a certificate associated with said configuration server and at least one network address allocated to said item of equipment by said configuration server.

7. A system comprising:
at least one item of equipment connected to at least one communication network,
at least one network address configuration server,
at least one certificate creation module,
at least one domain name server, and
at least one server of a service provider,
wherein:
the item of equipment is configured to transmit, to the configuration server, a request for allocating at least one network address comprising at least one hash of a physical address of said item of equipment,
the configuration server is configured to generate a creation request for creating a certificate associated with said item of equipment, the request comprising the at least one hash of the physical address of said item of equipment, a certificate associated with said configuration server and at least one network address allocated to said item of equipment by said configuration server,
the configuration server is configured to transmit said creation request to the certificate creation module,
the certificate creation module is configured to generate, from information comprised in the creation request, a certificate associated with said item of equipment and a certification token corresponding to said certificate,
the certificate creation module is configured to transmit, to the domain name server, a request for associating said certificate, said certification token and said hash of said certification token with at least one domain name,
the domain name server is configured to associate, with at least one domain name, the certificate associated with said item of equipment, the corresponding certification token and the hash of said certification token,
following an acknowledgement of the association with the domain name, the item of equipment is configured to receive the certification token and the hash of said certification token from the configuration server.

8. The system according to claim 7 wherein:
the item of equipment is configured to transmit a request for establishing a connection with a server of the at least one server of the service provider comprising at least said corresponding certification token and said hash of said certification token,
the server of the service provider is configured to verify the certification token using said hash of said certification token and a cryptographic key associated with said certificate creation module,
the server of the service provider is configured to verify the domain name associated with said certification token using said hash of said certification token and said certificate associated with said item of equipment,
in response to verification of the certification token and the domain name associated with the certification token, the server of the service provider is configured to transmit a message acknowledging establishment of said connection with said item of equipment.

9. The system according to claim 7, wherein the certificate creation module is comprised in the at least one network address configuration server.

10. An item of equipment connected to at least one communication network capable of establishing in an authenticated manner a connection with a server of a service provider, said item of equipment comprising:
at least one processor configured to:
transmit, to a network address configuration server, a request for allocating at least one network address comprising at least one hash of a physical address of said item of equipment,
receive a certification token corresponding to a certificate created by a certificate creation module from at least said at least one hash of the physical address of said item of equipment, and a hash of said certification token, and
transmit a request for establishing a connection with said server of the service provider comprising at least said corresponding certification token and said hash of said certification token.

11. A network address configuration server capable of providing a certification token associated with an item of equipment connected to at least one communication network for an authenticated establishment of a connection between said item of equipment and a server of a service provider, said network address configuration server comprising:
at least one processor configured to:
receive a request for allocating at least one network address comprising at least one hash of a physical address of said item of equipment,
obtain a certificate associated with said item of equipment and a certification token corresponding to said certificate, the certificate and the token being generated from the at least one hash of the physical address of said item of equipment, a certificate associated with said configuration server and at least one network address allocated to said item of equipment by said configuration server,
transmit said certification token and the hash of said certification token to said item of equipment.

12. A non-transitory computer readable medium comprising a computer program product stored thereon comprising program code instructions for implementing the method for authenticated establishment of the connection between the item of equipment and the server of the service provider according to claim 1, when the instructions are executed by a processor of the item of equipment.

13. A non-transitory computer readable medium comprising a computer program product stored thereon comprising program code instructions for implementing the method of providing the certification token associated with the item of equipment according to claim 3, when the instructions are executed by a processor of the network address configuration server.
